(19) United States
(12) Patent Application Publication
(10) Pub. No.: US 2026/0257471 A1
(43) Pub. Date: Sep. 3, 2026

(54) METHOD AND APPARATUS FOR ADJUSTING IMAGES

(71) Applicant: RISO KAGAKU CORPORATION, Tokyo (JP)

(72) Inventor: Junichi HAKAMADA, Tokyo (JP)

(73) Assignee: RISO KAGAKU CORPORATION, Tokyo (JP)

(21) Appl. No.: 19/542,990

(22) Filed: Feb. 18, 2026

(30) Foreign Application Priority Data
Mar. 3, 2025 (JP) 2025-032614

(51) Int. Cl. B41J 2/045

(52) U.S. Cl. CPC B41J 2/04508; B41J 2/04541; B41J 2/04573

(57) ABSTRACT

An image adjusting method for an inkjet printing device including a plurality of head groups each having a plurality of inkjet heads with a plurality of nozzles that eject ink onto a print medium, the inkjet heads in each head group being arranged along a direction perpendicular to a conveyance direction of at least one of the print medium and the inkjet heads, the head groups being arranged along the direction perpendicular to the conveyance direction. An image adjustment pattern that spans a joint between two head groups arranged adjacent to each other in a direction perpendicular to the conveyance direction is printed employing a portion of the inkjet heads in the two head groups, a read-out image is acquired by reading the printed image adjustment pattern with a readout unit, and an amount of image adjustment for the inkjet heads in the two head groups is determined.

### CROSS-REFERENCE TO RELATED APPLICATIONS

The present application claims priority under 35 U.S.C. §119 to Japanese Patent Application No. 2025-032614, filed on March 3, 2025. The above applications are hereby expressly incorporated by reference, in these entireties, into the present application.

### BACKGROUND OF THE INVENTION

### Field of the Invention

The present disclosure is related to an image adjusting method and an image adjusting apparatus for performing image adjustment among a plurality of head modules.

### Description of the Related Art

Inkjet printing apparatuses have been proposed that perform printing by ejecting ink from inkjet heads onto print media which are conveyed along a conveyance path.

As an inkjet printing apparatus of the above type, an inkjet printing apparatus has been proposed that realizes a high speed printing process by having an elongate line head with a plurality of short inkjet heads arranged in a direction perpendicular to the conveyance direction of the print medium, and ejecting ink from the line head onto the print medium to perform the printing process.

Japanese Unexamined Patent Publication No. 2011-73186 proposes a method for suppressing image degradation caused by positional misalignment of individual inkjet heads in an inkjet printing apparatus having the aforementioned line head.

### SUMMARY OF THE INVENTION

However, Japanese Unexamined Patent Publication No. 2011-73186 does not take an image adjusting method for large format printing using multiple head modules, each having a line head for each color, into consideration.

Simply installing head modules that have been image adjusted for the individual inkjet heads within each head module does not adjust the positioning or density among the head modules. Consequently, image quality degradation occurs at the joints between modules, such as gaps, overlaps, and density differences.

In addition, automatically adjusting a plurality of head modules together requires an image reading device capable of reading large format adjustment patterns. However, flatbed scanners capable of reading large format sheets are expensive, and as data volume increases, image processing devices (PCs) having high performance specifications are also required to analyze the read images. Further, overhead scanners and area cameras can cover large areas but suffer from low image quality (such as distortion and density fluctuations) and cannot perform accurate positional adjustments.

The present disclosure has been developed in view of the foregoing circumstances. The present disclosure provides an image adjusting method and an image adjusting apparatus capable of performing high precision image adjustment among a plurality of head modules employing general purpose, inexpensive equipment.

The image adjusting method of the present disclosure is an image adjusting method for an inkjet printing device that includes a plurality of head groups each having a plurality of inkjet heads with a plurality of nozzles that eject ink onto a print medium, the inkjet heads in each head group being arranged along a direction perpendicular to a conveyance direction of at least one of the print medium and the inkjet heads, the head groups being arranged along the direction perpendicular to the conveyance direction, wherein an image adjustment pattern that spans a joint between two head groups that are arranged adjacent to each other in a direction perpendicular to the conveyance direction is printed employing a portion of the inkjet heads in the two head groups, a read-out image is acquired by reading the printed image adjustment pattern with a readout unit, and an amount of image adjustment for the inkjet heads in the two head groups is determined based on the read-out image.

According to the image adjusting method of the present disclosure, an image adjustment pattern that spans the joint between two head groups arranged adjacent to each other in a direction perpendicular to the conveyance direction is printed using a portion of the inkjet heads in the two head groups, a read-out image of the printed image adjustment pattern is acquired by a readout unit, and an amount of image adjustment for the inkjet heads in the two head groups is determined based on the read-out image. This enables high precision image adjustment among a plurality of head groups using a general purpose and low cost device.

### BRIEF DESCRIPTION OF THE DRAWINGS

FIG. 1 is a block diagram that illustrates the schematic configuration of an inkjet printing system that employs an embodiment of an image adjusting method and an image adjusting apparatus of the present disclosure.

FIG. 2 is a diagram that illustrates the schematic configuration of a head unit.

FIG. 3 is a diagram that illustrates an arrangement relationship between a first head module and a second head module.

FIG. 4 is a flowchart that illustrates the image adjusting method performed in the inkjet printing system illustrated in FIG. 1.

FIG. 5 is a diagram that illustrates an inkjet head and a position adjustment pattern at a joint portion between the first head module and the second head module.

FIG. 6 is a diagram that illustrates an example of a method for calculating an amount of adjustment for ink ejection timings.

FIG. 7 is a diagram that illustrates adjustment values for the ink ejection timing of each inkjet head in the first head module and the second head module, amounts of adjustment for the ink ejection timings between the head modules, and adjusted ink ejection timings values that reflect the amounts of adjustment.

FIG. 8 is a diagram that illustrates a method for determining a driven nozzle range of inkjet heads at a joint portion.

FIG. 9 is a diagram that illustrates printing of a density adjustment pattern by the inkjet heads at the joint portion between the first head module and the second head module.

FIG. 10 is a diagram that illustrates an example of a method for calculating a density difference of the density adjustment pattern.

FIG. 11 is a diagram that illustrates an example of a table that shows a relationship between a density difference between heads and correction voltages.

FIG. 12 is a diagram that illustrates amounts of adjustment for the drive voltages of the first head module and the second head module

FIG. 13 is a diagram that illustrates adjustment values for the drive voltage of each inkjet head in the first and second head modules, amounts of adjustment between head modules, and adjusted drive voltage values that reflect the amounts of adjustment.

FIG. 14 is a diagram that illustrates a registration pattern in a case in which the first head module is tilted.

FIG. 15 is a diagram that illustrates an example in which a single head module is formed by arranging a plurality of inkjet heads in a direction perpendicular to the conveyance direction of a print medium.

### DETAILED DESCRIPTION OF THE EMBODIMENTS

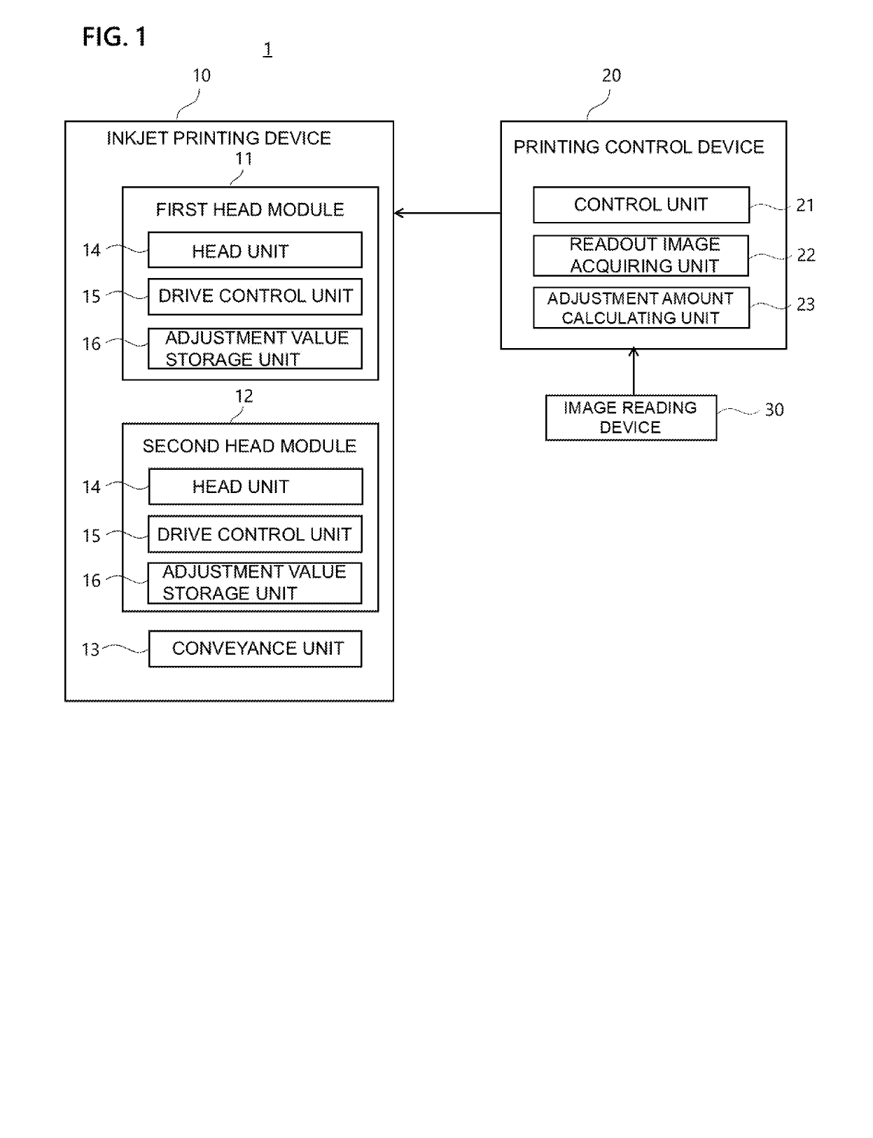

An inkjet printing system that employs an embodiment of the image adjusting method and apparatus of the present disclosure will be described in detail below, with reference to the attached drawings. The inkjet printing system of the present embodiment is characterized by an image adjusting method between adjacent head modules. First, the overall configuration of the inkjet printing system will be described with reference to FIG. 1.

The inkjet printing system of the present embodiment is equipped with an inkjet printing device 10, a printing control device 20, and an image reading device 30, as illustrated in FIG. 1.

The inkjet printing device 10 includes a first head module 11, a second head module 12, and a conveyance unit 13.

The first head module 11 and the second head module 12 perform printing processing on print media and each includes a head unit 14, a drive control unit 15, and an adjustment value storage unit 16.

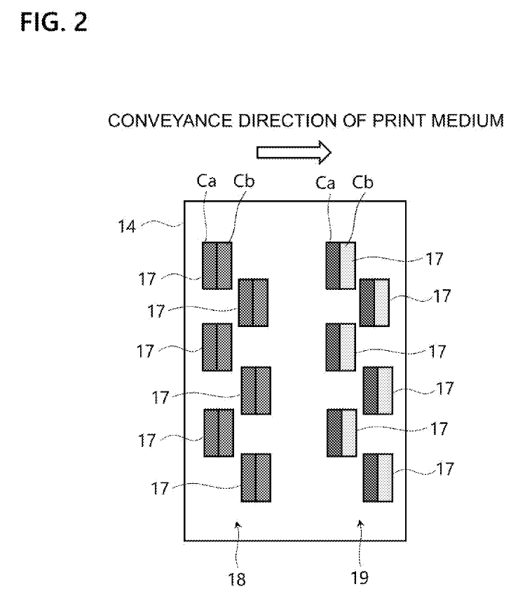

The head unit 14 has a plurality of nozzles arranged to eject ink onto a print medium P. Specifically, the head unit 14 is equipped with a line head 18 and a line head 19, as illustrated in FIG. 2.

The line head 18 and the line head 19 each have six inkjet heads 17. The six inkjet heads 17 are arranged in a staggered pattern perpendicular to a conveyance direction of the print medium P. Nozzles of adjacent inkjet heads 17 in the direction perpendicular to the conveyance direction are arranged such that they overlap.

For example, in the case that a straight line that extends perpendicular to the conveyance direction of the print medium P is printed employing the line head 18, ink is ejected from three inkjet heads 17 located upstream of the print medium P in the conveyance direction. Thereafter, ink is ejected from the remaining three inkjet heads 17 positioned downstream in the conveyance direction at a predetermined timing. Thereby, the six inkjet heads 17 that constitute the line head 18 print the straight line. The configuration of the six inkjet heads 17 in the line head 19 is the same as that of the line head 18.

The six inkjet heads 17 that constitute line head 18 eject two colors of ink, K (black) and C (cyan) ink, for example. Specifically, the inkjet head 17 has nozzle rows Ca and Cb arranged in a plurality of rows in a direction perpendicular to the conveyance direction, as illustrated in FIG. 2. The nozzle row Ca of the inkjet head 17 in line head 18 ejects K (black) ink, and the nozzle row Cb ejects C (cyan) ink.

The inkjet head 17 of the line head 19 ejects ink, for example, M (magenta) and Y (yellow) ink. Specifically, a nozzle row Ca of the inkjet head 17 in the line head 19 ejects M (magenta) ink, and a nozzle row Cb ejects Y (yellow) ink.

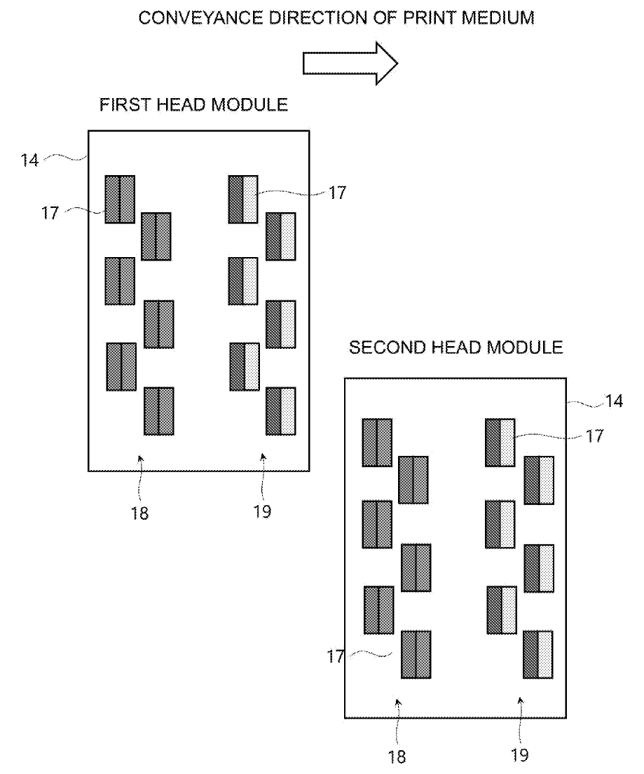

As illustrated in FIG. 3, the head unit 14 of the first head module 11 and the head unit 14 of the second head module 12 are arranged in a direction perpendicular to the conveyance direction of the print medium P. The head unit 14 of the second head module 12 is positioned downstream of the head unit 14 of the first head module 11. The four inkjet heads 17 which are positioned in the vicinity of a joint between the head unit 14 of the first head module 11 and the head unit 14 of the second head module 12 are arranged such that a portion of the nozzles thereof overlap. Note that an overlap width within which the nozzles overlap will be described in detail later.

For example, in the case that the first head module 11 and the second head module 12 are employed to print straight lines K (black) and C (cyan) that extend perpendicular to the conveyance direction of the print medium P, first, ink is ejected from the line head 18 of the first head module 11, which is positioned upstream in the conveyance direction of the print medium P. Thereafter, ink is ejected from the line head 18 of the second head module 12, which is positioned downstream, at a predetermined timing. Thereby, the straight lines K (black) and C (cyan) are printed.

Similarly, in the case that the first head module 11 and the second head module 12 are employed to print straight lines M (magenta) and Y (yellow) that extend perpendicular to the conveyance direction of the print medium P, first, ink is ejected from the line head 19 of the first head module 11, which is positioned upstream on the conveyance path of the printed medium P. Thereafter, ink is ejected from the line head 19 of the second head module 12, which is positioned downstream, at a predetermined timing. Thereby, the straight lines M (magenta) and Y (yellow) are printed.

The drive control unit 15 drives and controls the inkjet heads 17 of the line heads 18 and 19 of the head unit 14. Thereby, the timing at which and the volume of ink (density) ejected by each of the ink jet heads 17 are controlled

The adjustment value storage unit 16 stores adjustment values for the ink ejection timing and adjustment values for the drive voltage of each inkjet head 17 of the line heads 18 and 19 of the head unit 14. Note that the adjustment values for the ink ejection timing and the drive voltage are for adjusting shifts in ink ejection timings and shifts in density between the first head module 11 and the second head module 12 in the conveyance direction. The method for calculating these adjustment values will be described in detail later.

The conveyance unit 13 conveys the print medium P in the conveyance direction. The conveyance unit 13 has a conveyance mechanism such as a conveyor belt and conveyor rollers.

Next, returning to FIG. 1, the printing control device 20 will be described. The printing control device 20 of the present embodiment includes an embodiment of the image adjusting apparatus of the present disclosure. The printing control device 20 of the present embodiment performs printing processes by controlling the first head module 11, the second head module 12, and the conveyance unit 13 described above. In addition, the printing control device 20 calculates the shifts in the ink ejection timings and density between the first head module 11 and the second head module 12 described above, and performs image adjustment by adjusting for these shifts.

The printing control device 20, as illustrated in FIG. 1, is equipped with a control unit 21, a readout image acquiring unit 22, and an adjustment amount calculating unit 23.

The control unit 21 controls the printing operations of the first head module 11 and the second head module 12. In addition to controlling printing operations based on image data of a normal target of printing, the control unit also controls printing operations based on a preset position adjustment pattern and a preset density adjustment pattern. The printing operations for the position adjustment pattern and the density adjustment pattern will be described in detail later.

The readout image acquiring unit 22 acquires read-out image data of the position adjustment pattern and read-out image data of the density adjustment pattern, which are read by the image reading device 30 to be described later.

The adjustment amount calculating unit 23 calculates the amount of shift in the ink ejection timings between the first head module 11 and the second head module 12 based on the read-out image data of the position adjustment pattern acquired by the readout image acquiring unit 22, and calculates an amount of adjustment for the ink ejection timing of each inkjet head 17 of the first head module 11 and each inkjet head 17 of the second head module 12 based on the calculated amount of shift.

In addition, the adjustment amount calculating unit 23 calculates the amount of shift in the density between the first head module 11 and the second head module 12 based on the read-out image data of the density adjustment pattern acquired by the readout image acquiring unit 22, and calculates an amount of adjustment for the drive voltage of each inkjet head 17 of the first head module 11 and each inkjet head 17 of the second head module 12 based on the calculated amount of density shift.

The amounts of adjustment calculated by the adjustment amount calculating unit 23 are output to the first head module 11 and the second head module 12, and stored in the adjustment value storage unit 16.

The print control device 20 includes a CPU (Central Processing Unit), semiconductor memory, a hard disk, etc. The printing control device 20 executes a program which is stored in advance in the semiconductor memory or hard disk and operates electrical circuits to control the operations of the components of the print control device 20 described above.

The image reading device 30 is connected to the print control device 20 and optically reads printouts of the position adjustment pattern and the density adjustment pattern to acquire read-out image data. In the present embodiment, a scanner which is capable of reading printed materials up to A4 size is employed as the image reading device 30. However, the present disclosure is not limited to such a configuration, and a scanner capable of reading printed materials up to A3 size or other commercially available general purpose scanners may be employed. In the present embodiment, the image reading device 30 corresponds to the readout unit of the present disclosure.

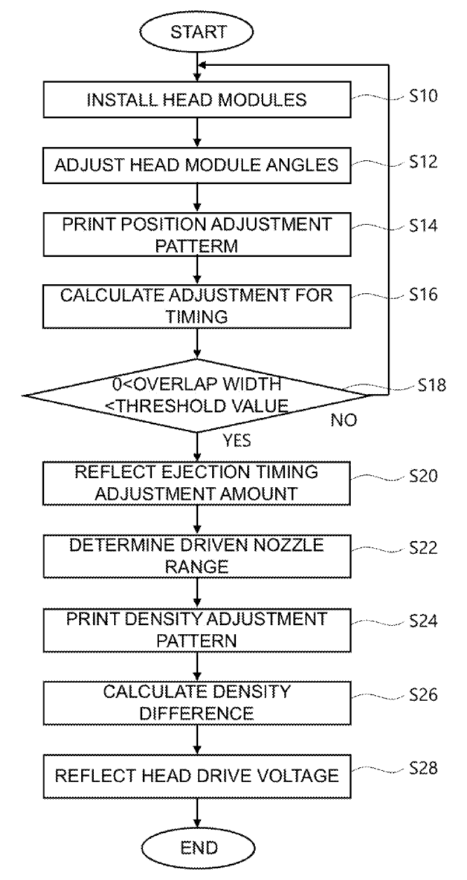

Next, the image adjusting method in the inkjet printing system 1 of the present embodiment will be described with reference to the flowchart illustrated in FIG. 4. Note that the twelve inkjet heads 17 within the first head module 11 and the twelve inkjet heads 17 within the second head module 12 are designated as those which have already undergone image adjustment. Here, the image adjustment is performed between the first head module 11 and the second head module 12.

First, the first head module 11 and the second head module 12 are installed in approximate positions (S10). Then, printing is performed using all of the inkjet heads 17 in the first head module 11 and the second head module 12, and the result of printing is visually inspected to achieve a state in which the joint portion between the head unit 14 of the first head module 11 and the head unit 14 of the second head module 12 overlap.

Next, angle adjustments are performed for each of the first head module 11 and second head module 12 with respect to the conveyance direction (S12). Here, a user performs the angle adjustments based on the result of printing from step S10 which was visually inspected by the user.

Next, using a print medium P of a size readable by the image reading device 30, a position adjustment pattern is printed employing all nozzles of the inkjet head 17 at the joint portion between the head unit 14 of the first head module 11 and the head unit 14 of the second head module 12 (S14).

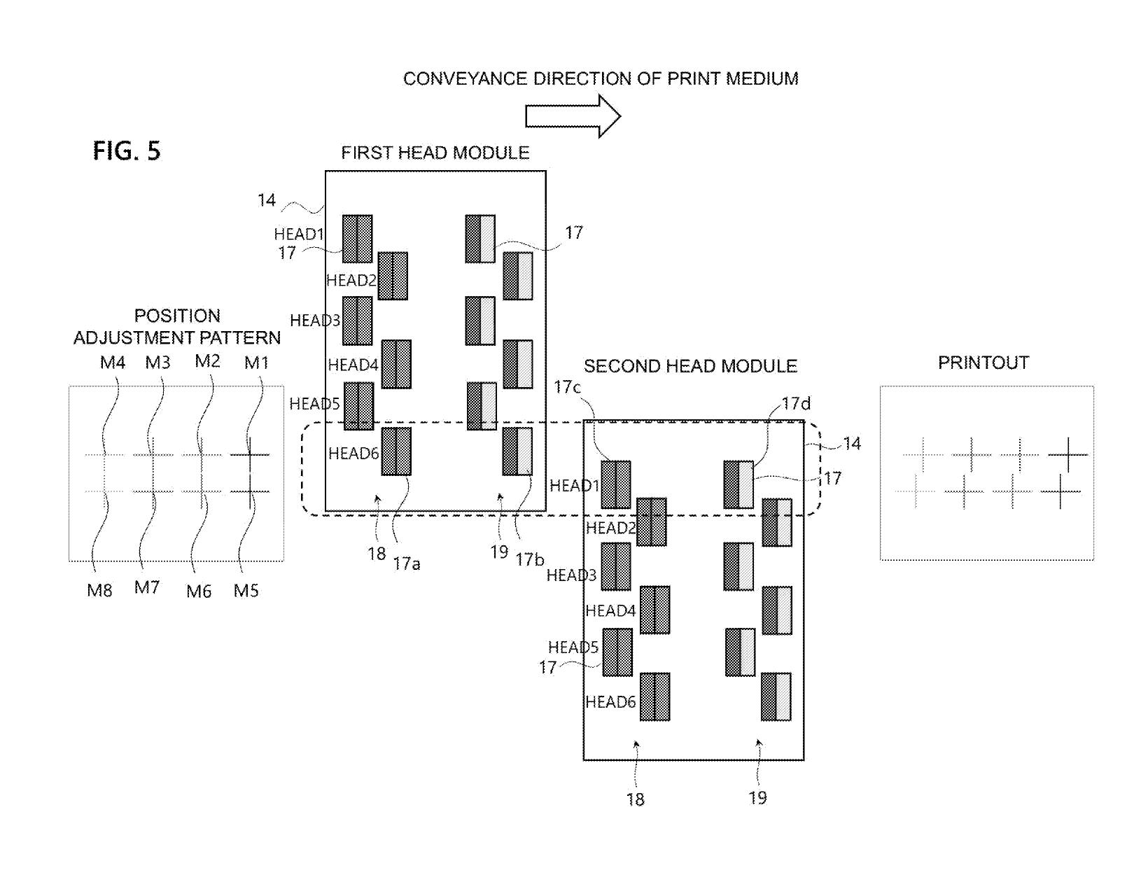

In the present embodiment, the inkjet heads 17a and 17b of the head unit 14 of the first head module 11 positioned closest to the second head module 12, and the inkjet heads 17c and 17d of the head unit 14 of the second head module 12 positioned closest to the first head module 11 are employed as the inkjet heads 17 at the joint portion, as indicated by the dotted rectangle in FIG. 5.

In the present embodiment, a cruciform mark (position registration mark) such as that illustrated in FIG. 5 is printed as the position adjustment pattern. Image data of the position adjustment pattern is illustrated at the left side of FIG. 5. That is, the image data represents the position of the mark in the case that the four inkjet heads 17 at the joint portion eject ink at optimal timings. The position adjustment pattern illustrated at the right side of FIG. 5 indicates the position of the mark in the actual printout.

The position adjustment pattern contains registration marks M1 through M8 for each color printed by the inkjet heads 17a through 17d at the joint portion. The K (black) registration mark M1 and the C (Cyan) registration mark M2 are printed by inkjet head 17a of the first head module 11, while the magenta (M) registration mark M3 and the yellow (Y) registration mark M4 are printed by the inkjet head 17b of the first head module 11. The K (black) registration mark M5 and the C (cyan) registration mark M6 are printed by the inkjet head 17c of the second head module 12. In addition, the M (magenta) registration mark M7 and the Y (yellow) registration mark M8 are printed by the inkjet head 17d of the second head module 12.

The position adjustment pattern printed in S14 is read by the image reading device 30, and read-out image data thereof is acquired by the readout image acquiring unit 22 of the print controller 20. Then, the adjustment amount calculating unit 23 calculates amounts of adjustment for the ink ejection timing between the head unit 14 of the first head module 11 and the head unit 14 of the second head module 12 based on the read-out image data of the position adjustment pattern (S16).

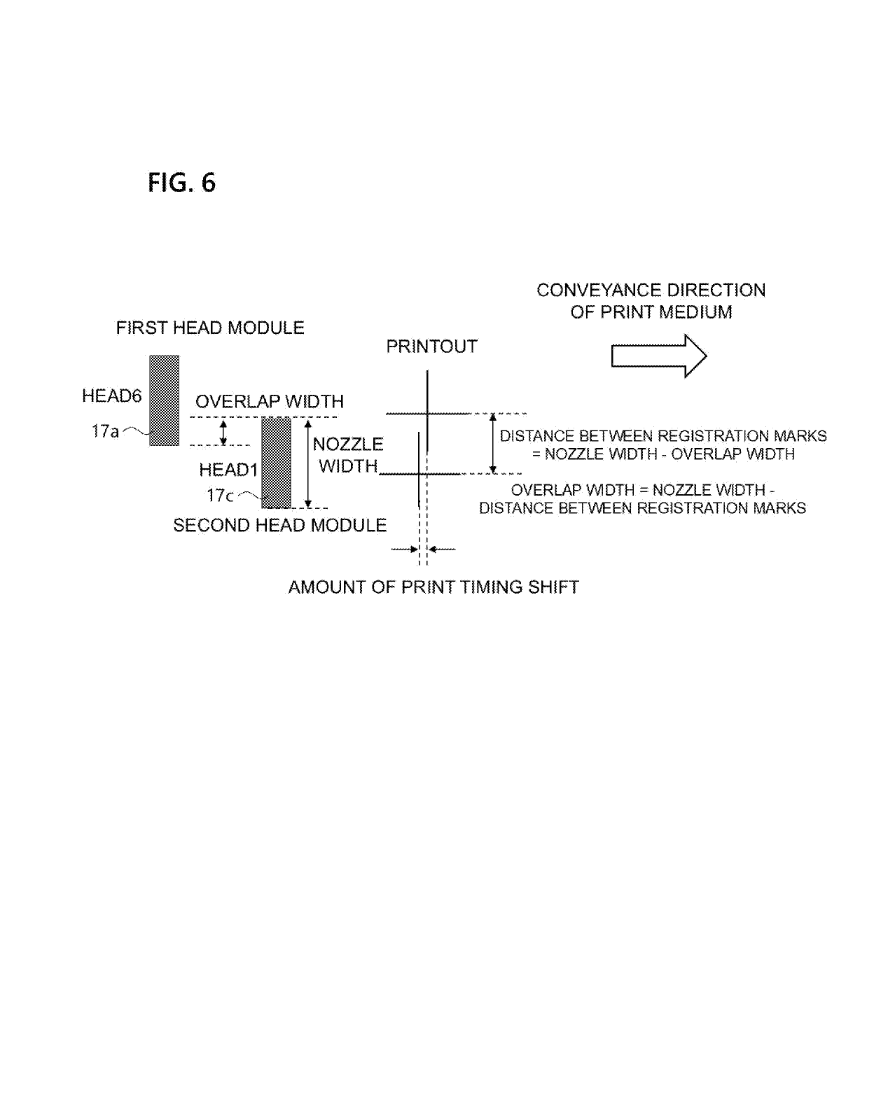

FIG. 6 is a diagram that illustrates an example of a method for calculating the amounts of adjustment for the ink ejection timing. FIG. 6 shows the ink jet nozzle head 17a and ink jet head 17c at the joint portion between the first head module 11 and the second head module 12, the registration mark M1 printed by the inkjet head 17a, and the registration mark M5 printed by the inkjet head 17c.

The adjustment amount calculating unit 23 calculates the amount of adjustment for the ink ejection timing based on the positional information of registration marks M1 and M5. Specifically, the adjustment amount calculating unit 23 obtains positional information for a straight line parallel to the direction perpendicular to the conveyance direction at the registration marks M1 and M5. Then, the adjustment amount calculating unit 23 determines an amount of positional shift from a predetermined reference position for each positional information, to calculate the amount of adjustment for the ink ejection timing.

In addition, the adjustment amount calculating unit 23, while obtaining the aforementioned amount of positional shift, also calculates the overlap width between inkjet head 17a and inkjet head 17c based on the position information of registration marks M1 and M5. Specifically, as illustrated in FIG. 6, a distance between marks, which is a distance between a line segment parallel to the conveyance direction at the registration mark M1 and a line segment parallel to the conveyance direction at the registration mark M5, is obtained. The distance between marks is subtracted from the nozzle width illustrated in FIG. 6. The overlap width calculated here corresponds to the overlap width between the head unit 14 of the first head module 11 and the head unit 14 of the second head module 12.

Then, the control unit 21 checks whether the overlap width calculated by the adjustment amount calculating unit 23 is a positive value and is less than a predetermined threshold value (S18). If the overlap width is zero or less, there is no overlap between the head unit 14 of the first head module 11 and the head unit 14 of the second head module, and a gap will appear in printed material. On the other hand, if the overlap width is greater than or equal to the predetermined threshold value, the overlap is excessively large, it will not be possible to secure a desired printing width on the printed material. Therefore, in the case that the overlap width is zero or less or above a predetermined threshold (S18, NO), the control unit 21 prompts the user to perform the processes from S10 to S14 again.

On the other hand, if the overlap width calculated by the adjustment amount calculating unit 23 is a positive value and is less than the predetermined threshold value (S18, YES), the adjustment amount calculating unit 23 outputs the amounts of adjustment for the ink ejection timing calculated in S16 to the inkjet printing device 10, and causes adjustment values for the ink ejection timing for each of the inkjet heads 17 of the first head module 11 and adjustment values for the ink ejection timing for each of the inkjet heads 17 of the second head module 12 to be reflected (S20).

Specifically, the adjustment value storage unit 16 of the first head module 11 stores the adjustment values for the ink ejection timing among the inkjet heads 17 in the first head module 11. The adjustment value storage unit 16 of the second head module 12 stores the adjustment values for the ink ejection timing among the inkjet heads 17 in the second head module 12.

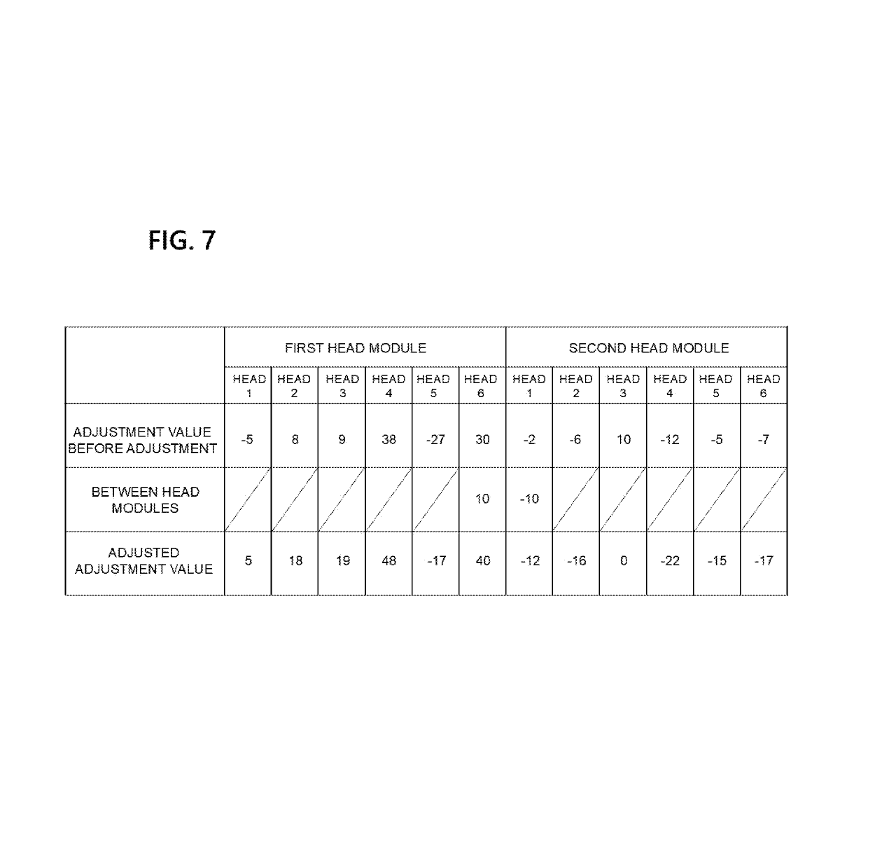

FIG. 7 shows the adjustment values (before adjustment) for the ink ejection timing of the inkjet heads 17 in the first head module 11 and the second head module 12, the amounts of adjustment (between head modules) for the ink ejection timing calculated by the adjustment amount calculating unit 23, and the adjusted values after reflecting the amount of adjustment (after adjustment). In the numerical values illustrated in FIG. 7, a positive value means delaying the ejection timing by that amount relative to the reference position, while a negative value means advancing the ejection timing by that amount relative to the reference position. The units of the numerical values illustrated in FIG. 7 are μm.

Here, based on the positions of the registration marks M1 and M5 illustrated in FIG. 6, the inkjet head 17a that printed the registration mark M1 has an ink ejection timing earlier than the reference, and the inkjet head 17c that printed the registration mark M5 has an ink ejection timing delayed relative to the reference.

The adjustment amount calculating unit 23 then calculates an amount of adjustment of "10" for the ink ejection timing of the first head module 11 and calculates an amount of adjustment of “-10” for the ink ejection timing of the second head module 12.

The amount of adjustment for the ink ejection timing of the first head module 11, calculated by the adjustment amount calculating unit 23, is acquired by the drive control unit 15 of the first head module 11. The drive control unit 15 calculates and sets the adjusted value by adding the input amount of adjustment for the ink ejection timing to the value before adjustment. In the table illustrated in FIG. 7, the amount of adjustment "10" for the ink ejection timing is added to all adjustment values of the six inkjet heads 17 (head 1 through head 6) of the first head module 11 for printing K (black), and the adjusted values after adjustment are set.

In addition, the amount of adjustment for the ink ejection timing of the second head module 12, calculated by the adjustment amount calculating unit 23, is acquired by the drive control unit 15 of the second head module 12. The drive control unit 15 calculates and sets the adjusted value by adding the input amount of adjustment for the ink ejection timing to the value before adjustment. In the table illustrated in FIG. 7, the amount of adjustment "-10" for the ink ejection timing is added to all adjustment values of the six inkjet heads 17 (head 1 through head 6) of the second head module 12 for printing K (black), and the adjusted values after adjustment are set.

Then, the drive control units 15 of the first head module 11 and the second head module 12 refer to the adjusted values shown in the table of FIG. 7 to control the ink ejection timing of each inkjet head 17.

Note that the table illustrated in FIG. 7 is of an example in which for the first head module 11, the amount of adjustment for the ink ejection timing is determined based on the position information of the registration mark M1 printed by the inkjet head 17a and added to the adjustment values of the six inkjet heads 17 that print K (Black). The same amount of adjustment ("10") is added to the adjustment values for the ink ejection timing of the six inkjet heads 17 that print M (magenta) and Y (Yellow). However, the present disclosure is not limited to such a configuration. With respect to the six inkjet heads 17 that print magenta (M) and Y (yellow), an amount of adjustment may be calculated employing position information of the M (magenta) registration mark M3 illustrated in FIG. 5, and add the amount of adjustment to the adjustment value for the ink ejection timing of the six inkjet heads 17 that print M (magenta) and Y (yellow).

In addition, for the first head module 11, the amount of adjustment for the ink ejection timing is calculated based on the position information of the K (black) registration mark M1. Alternatively, the amount of adjustment for the ink ejection timing may be calculated based on the position information of the C (Cyan) registration mark M2. As a further alternative, a mean of the amount of adjustment for the ink ejection timing is calculated based on the position information of the K (black) registration mark M1 and the amount of adjustment for the ink ejection timing is calculated based on the position information of the C (cyan) registration mark M2 may be calculated and utilized.

Further, for the second head module 12, the same amount of adjustment ("-10") is similarly added to the adjustment values for the ink ejection timing of the six inkjet heads 17 that print M (magenta) and Y (Yellow). However, the present disclosure is not limited to such a configuration. With respect to the six inkjet heads 17 that print magenta (M) and Y (yellow), an amount of adjustment may be calculated employing position information of the M (magenta) registration mark M3 illustrated in FIG. 5, and add the amount of adjustment to the adjustment value for the ink ejection timing of the six inkjet heads 17 that print M (magenta) and Y (yellow).

Still further, for the second head module 12, the amount of adjustment for the ink ejection timing is calculated based on the position information of the K (black) registration mark M5. Alternatively, the amount of adjustment for the ink ejection timing may be calculated based on the position information of the C (Cyan) registration mark M6. As a further alternative, a mean of the amount of adjustment for the ink ejection timing is calculated based on the position information of the K (black) registration mark M5 and the amount of adjustment for the ink ejection timing is calculated based on the position information of the C (cyan) registration mark M6 may be calculated and utilized.

Next, the overlap width calculated by the adjustment amount calculating unit 23 is output to the drive control units 15 of the first head module 11 and the second head module 12. The drive control unit 15 adjusts the ink ejection timing of the inkjet head 17a and the inkjet head 17c at the joint portion between the first head module 11 and the second head module 12 based on the input overlap width (S22).

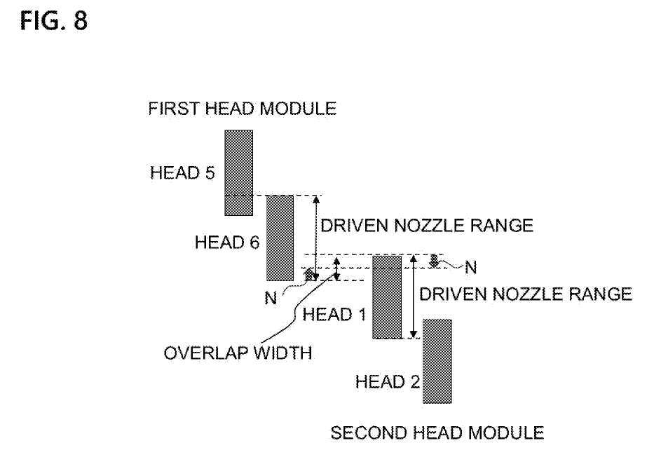

FIG. 8 is a diagram for explaining a method for determining a driven nozzle range of the inkjet heads 17 at the joint portion. As illustrated in FIG. 8, the drive control unit 15 determines a range which is nozzles N that correspond to half the overlap width excluded from the driven nozzle range of the inkjet head 17c (head 1) based on the driven nozzle range of the inkjet head 17a (head 6) as the actual driven nozzle range to be used (S23). In addition, with respect to the M (magenta) and Y (yellow) inkjet heads 17b and 17d at the joint portion, the drive control unit 15 similarly determines a range which is nozzles N that correspond to half the overlap width excluded from the driven nozzle ranges of these inkjet heads.

Next, using a print medium P of a size readable by the image reading device 30, the density adjustment pattern is printed using all nozzles of the inkjet head 17 at the joint portion between the head unit 14 of the first head module 11 and the head unit 14 of the second head module 12 (S24).

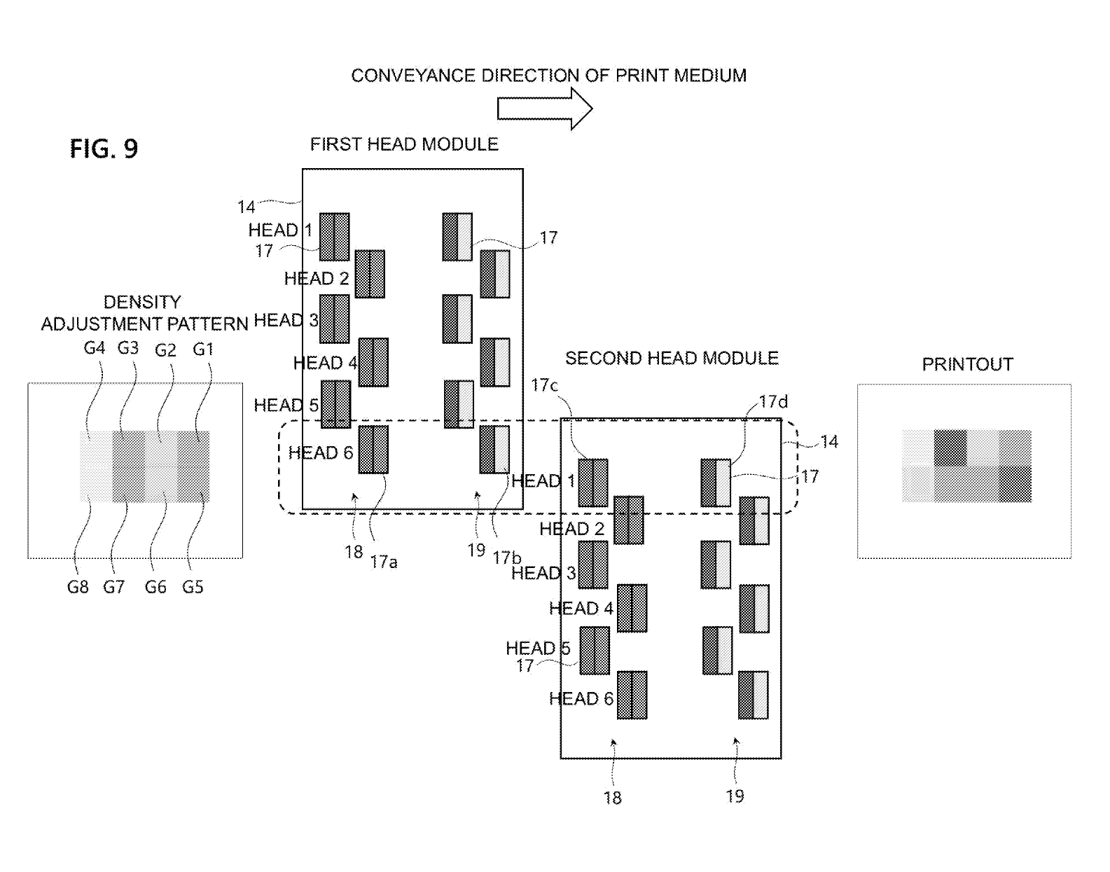

In the present embodiment, a solid image with uniform density, such as the rectangular image illustrated in FIG. 9, is printed as the density adjustment pattern. The density adjustment pattern shown on the left side of FIG. 9 indicates the image data of the solid image to be printed, while the density adjustment pattern shown on the right side of FIG. 9 indicates the solid images of each color on the printout after actual printing.

The image data for the density adjustment pattern includes solid images of each color printed by the inkjet heads 17 at the joint portion. The solid K (black) image G1 and the solid C (cyan) image G2 are printed by the inkjet head 17a of the first head module 11, while the solid M (magenta) image G3 and the solid Y (yellow) image G4 are printed by the inkjet head 17b of the first head module 11. The solid image G5 for K (black) and the solid image G6 for C (cyan) are printed by the inkjet head 17c of the second head module 12, while the solid image G7 for M (magenta) and the solid image G8 for Y (yellow) are printed by the inkjet head 17d of the second head module 12.

The density adjustment pattern printed in S24 is read by the image reading device 30, and the read-out image data is acquired by the readout image acquiring unit 22 of the print control device 20. Then, the adjustment amount calculating unit 23 calculates a density difference between the head unit 14 of the first head module 11 and the head unit 14 of the second head module 12 based on the read-out image data of the density adjustment pattern (S26).

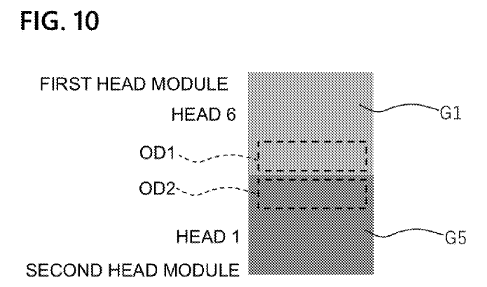

FIG. 10 is a diagram that illustrates an example of a method for calculating the density difference of the density adjustment pattern. The adjustment amount calculating unit 23 calculates the density difference between the solid K (black) image G1 printed by the inkjet head 17a of the first head module 11 and the solid K (black) image G5 printed by the inkjet head 17c. At this time, a density OD1 and a density OD2 are obtained in the area near the boundary between the solid K (black) image G1 and the solid K (black) image G5 (the area indicated by the dashed rectangle in FIG. 10) as illustrated in FIG. 10, and the difference between density OD1 and density OD2 is calculated as the density difference.

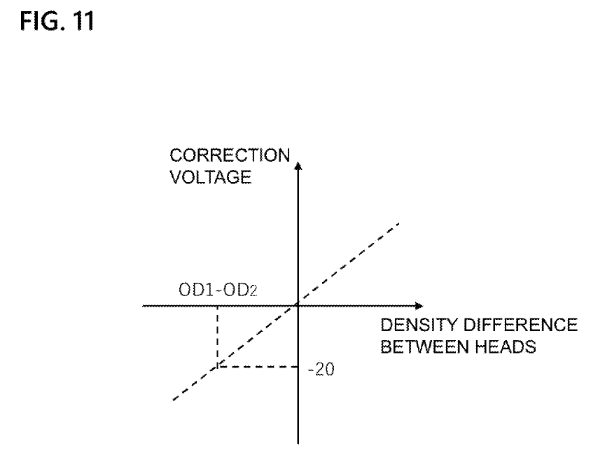

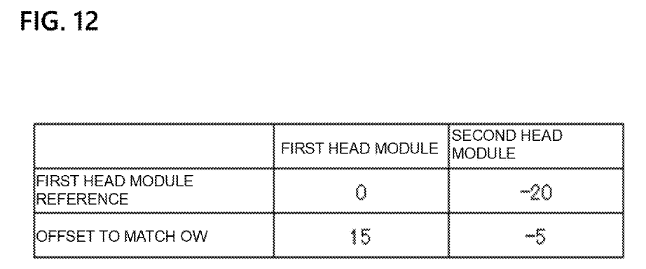

Next, the adjustment amount calculating unit 23 calculates the amount of adjustment for the drive voltage of the K (black) nozzle of the inkjet head 17a in the first head module 11 and the amount of adjustment for the drive voltage of the K (black) nozzle of the inkjet head 17c in the second head module 12, based on the density difference OD1 - OD2 calculated in S26 (S28). Specifically, the adjustment amount calculating unit 23 has a preset table, such as that illustrated in FIG. 11, which shows the relationship between the density difference between heads and correction voltages. The adjustment amount calculating unit 23 determines the correction voltage based on the density difference OD1-OD2 calculated in S26 and the table illustrated in FIG. 11, and calculates the amount of adjustment for the drive voltage based on the correction voltage. For example, if the correction voltage corresponding to the density difference OD1-OD2 is “-20”, then employing the inkjet head 17a of the first head module 11 as a reference, the amount of adjustment for the inkjet head 17a of the first head module 11 is zero, and the amount of adjustment for the inkjet head 17c of the second head module 12 is “-20”, as illustrated in FIG. 12. Offsetting this amount of adjustment by a ratio of 3:1 to an OW (Operation Window, favorable print range (OW) that represents the proper operating range of the inkjet head 17, the amount of adjustment for the K (black) nozzle of the inkjet head 17a of the first head module 11 becomes “15”, and the amount of adjustment for the K (black) nozzle of inkjet head 17c of the second head module 12 becomes “-5”.

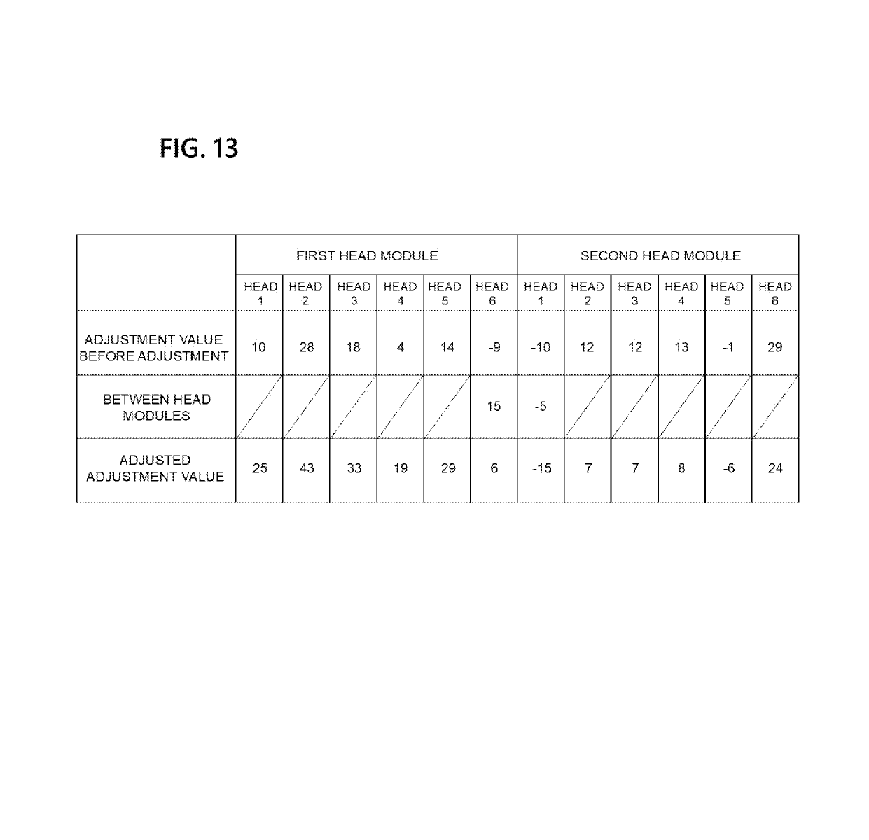

FIG. 13 illustrates the adjustment values (before adjustment) of the drive voltages for the K (black) nozzles of each of the inkjet head 17 in the first head module 11 and the second head module 12, the amounts of adjustment (amounts of adjustment between head modules) for the drive voltage of the K (black nozzles) calculated by the adjustment amount calculating unit 23, and the adjusted values (after adjustment) that reflect the amounts of adjustment. The numerical values illustrated in FIG. 13 indicate that a positive value means the drive voltage is higher than the reference voltage by that amount, and a negative value means the drive voltage is lower than the reference voltage by that amount.

In the example illustrated in FIG. 13, “15” is set as the amount of adjustment for the drive voltage of the K (black) nozzle of inkjet head 17a of the first head module 11, and “-5” is set as the amount of adjustment for the drive voltage of the K (black) nozzle of inkjet head 17c of the second head module 12.

The amount of adjustment for the drive voltage of the K (black) nozzle of inkjet head 17a in the first head module 11, calculated by the adjustment amount calculating unit 23, is acquired by the drive control unit 15 of the first head module 11. The drive control unit 15 calculates and sets the adjusted adjustment value by adding the input amount of adjustment for the drive voltage to the adjustment value before adjustment. In the table illustrated in FIG. 13, the amount of adjustment “15” for the drive voltage of the K (Black) nozzle of inkjet head 17a is added to all of the adjustment values of the nozzles printing K (Black) in the six inkjet heads 17 (head 1 through head 6) of the first head module 11, and the adjusted adjustment value is set.

In addition, the amount of adjustment for the drive voltage of the K (black) nozzle of inkjet head 17c of the second head module 12, calculated by the adjustment amount calculating unit 23, is acquired by the drive control unit 15 of the second head module 12. The drive control unit 15 calculates and sets the adjusted adjustment value by adding the input amount of adjustment for the drive voltage to the adjustment value before adjustment. In the table illustrated in FIG. 13, the amount of adjustment “-5” for the drive voltage of the K (black) nozzle of inkjet head 17a is added to all of the adjustment values of the K (black) nozzles of the six inkjet heads 17 (Head 1 to Head 6) of the second head module 12, and the adjusted adjustment value is set.

Then, the drive control units 15 of the first head module 11 and the second head module 12 control the drive voltage of the K (black) nozzle of each inkjet head 17 by referring to the adjusted values shown in the table of FIG. 13.

Note that the description above explained the method for adjusting the drive voltage of the nozzles that print K (Black) in the first head module 11 and the second head module 12. However, the nozzles that print C (Cyan), M (Magenta), and Y (Yellow) are also adjusted using the same method for each color.

Specifically, for the nozzles that print C (cyan), a correction voltage is determined based on the density difference between the solid cyan image G2 printed by the inkjet head 17a at the joint portion and the solid cyan image G6 printed by the inkjet head 17c at the joint portion. The amount of adjustment for the drive voltage of the cyan nozzles is then calculated based on this correction voltage. Then, for the first head module 11, the adjustment value for the Cyan (C) nozzle of the inkjet head 17a in the joint portion is added to the adjustment values for the Cyan (C) nozzles of the six inkjet heads 17 (head 1 through head 6) that print Cyan (C), resulting in the respective adjusted values. Similarly, for the second head module 12, the adjustment values for the Cyan (C) nozzles of the six inkjet heads 17 (head 1 through head 6) that print Cyan (C) are obtained by adding the amount of adjustment for the Cyan (C) nozzle drive voltage of the inkjet head 17c at the joint portion.

For the nozzles that print M (magenta), a correction voltage is determined based on the density difference between the solid magenta image G3 printed by the inkjet head 17b at the joint portion and the solid magenta image G7 printed by the inkjet head 17d at the joint portion. and the amount of adjustment for the M (magenta) nozzle drive voltage is calculated based on this correction voltage. Then, for the first head module 11, the amount of adjustment for the M (magenta) nozzle of the inkjet head 17b at the joint portion is added to the adjustment values for the M (magenta) nozzles of the six inkjet heads 17 that print M (magenta), resulting in the respective adjusted values. Similarly, for the second head module 12, the amount of adjustment for the M (magenta) nozzle drive voltage of the inkjet head 17d in the joint portion is added to the adjustment values for the M (magenta) nozzles of the six inkjet heads 17 that print M (magenta), resulting in the respective adjusted values.

For the nozzles that print Y (Yellow), a correction voltage is determined based on the density difference between the solid Y (Yellow) image G4 printed by the inkjet head 17b in the joint portion and the solid Y (Yellow) image G8 printed by the inkjet head 17d at the joint portion. Based on this correction voltage, the amount of adjustment for the drive voltage of the Y (Yellow) nozzles is calculated. Then, for the first head module 11, the amount of adjustment for the drive voltage of the Y (Yellow) nozzle of the inkjet head 17b in the joint portion is added to the adjustment values for the Y (Yellow) nozzles of the six inkjet heads 17 printing Y (Yellow), resulting in the respective adjusted values. Similarly, for the second head module 12, the amount of adjustment for the drive voltage of the Y (Yellow) nozzle of the inkjet head 17d in the joint portion is added to the adjustment values for the Y (Yellow) nozzles of the six inkjet heads 17 printing Y (Yellow), resulting in the respective adjusted values.

In addition, in the inkjet printing system 1 of the embodiment described above, the ink ejection timing is adjusted employing a position adjustment pattern. However, the installation angle of the first head module 11 and the second head module 12 may also be adjusted using the position adjustment pattern. For example, the registration mark M1 printed by the inkjet head 17a of the first head module 11 at the joint portion and the registration mark M5 printed by the inkjet head 17c of the second head module 12 at the joint portion are employed.

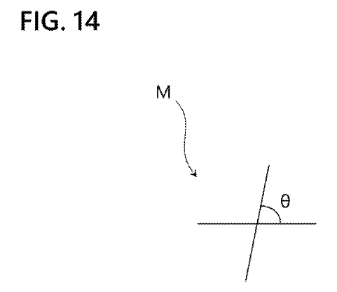

For example, in the case that the installation angle of the first head module 11 is tilted, as illustrated in FIG. 14, one of the two line segments that constitute the registration mark M, which should extend in a direction perpendicular to the conveyance direction, becomes inclined with respect to to the direction perpendicular to the conveyance direction. Therefore, the installation angle of each inkjet head 17 of the first head module 11 is adjusted such that the inclination angle θ illustrated in FIG. 14 becomes 90°. Similarly, the installation angle of the second head module 12 can also be adjusted using the registration mark M5. As a result, the installation angle between the first head module 11 and the second head module 12 can be adjusted.

However, the installation angle adjusting method described above presumes that, for the first head module 11, the installation angles of the inkjet head 17a at the joint portion of the first head module 11 and the other inkjet heads 17 of the first head module 11 are the same.

However, in the case that the inkjet head 17a at the joint portion is replaced, for example, the installation angles of the inkjet head 17a at the joint portion and the other inkjet heads 17 may not be aligned. In this case, as illustrated in FIG. 5, if a single inkjet head 17a is employed as the inkjet head 17 at the joint portion to print a position adjustment pattern and adjust the installation angle, depending on the installation angle, the registration pattern may be printed only partially. Similarly, for the second head module 12, in the case that the inkjet head 17c is replaced, the registration pattern may also be printed only partially.

Therefore, in the case that the inkjet head 17a at the joint portion is replaced, for example, the number of inkjet heads 17 at the joint portion used for installation angle adjustment may be increased. This increases the number of registration marks used for adjustment. The installation angle can then be adjusted using a mean value of the angles of inclination θ calculated from a plurality of registration marks.

Specifically, in the case that the inkjet head 17a in the joint portion is replaced, the user inputs this setting into the print control device 20. The control unit 21 then outputs a control signal to the drive control unit 15 of the first head module 11 to increase the number of the inkjet heads 17 at the joint portion. The drive control unit 15 of the first head module 11 increases the number of the inkjet heads 17 that print registration marks in response to the input control signal.

Specifically, in the embodiment described above, the inkjet head 17a located closest to the second head module 12 among the inkjet heads 17 of the first head module 11 is designated as the inkjet head at the joint portion. Alternatively, the first and second inkjet heads 17 from the side of the second head module 12 (heads 5 and 6) may be designated as the inkjet heads at the joint portion, or the first through third inkjet heads 17 from the side of the second head module (heads 4, 5, and 6) may be designated as the inkjet heads at the joint portion, for example. Similarly, in the case that the inkjet head 17c at the joint portion of the second head module 12 is replaced, the number of inkjet heads 17 at the joint portion printing the registration marks is increased. Note that the maximum number of inkjet heads 17 at the joint portion is limited by the readable size of the image reading device 30.

In addition, the control unit 21 of the print control device 20 may acquire the readable size of the image reading device 30, and change the number of inkjet heads 17 at the joint portion that prints registration marks, based on the acquired readable size. The method for increasing the number of inkjet heads 17 at the joint portion is the same as that described above.

According to the inkjet printing system 1 of the embodiment described above, a position adjustment pattern and a density adjustment pattern that spans the joint portion between the first head module 11 and the second head module 12, that are arranged adjacent to each other in a direction perpendicular to the conveyance direction, are printed employing a portion of the inkjet heads 17 in the first and second head modules 11 and 12, and the image reading device 30 acquires read-out image data by reading the printed position adjustment pattern and density adjustment pattern. The amounts of image adjustment (amount of adjustment of ink ejection timing and drive voltage) of the inkjet heads 17 in the first head module 11 and the second head module 12 are determined based on the acquired read-out image data. Therefore, when performing image adjustment between the first head module 11 and the second head module 12, high precision image adjustment is possible using general purpose size sheets and a general purpose low cost scanner without employing large format sheets or large format scanners.

In addition, in the inkjet printing system 1 of the embodiment described above, the amount of image adjustment between the first head module 11 and the second head module 12 is determined after performing image adjustment among the inkjet heads 17 included in the first head module 11 and image adjustment among the inkjet heads 17 included in the second head module 12. This enables higher precision adjustment.

Further, in the inkjet printing system 1 of the embodiment described above, after determining the amount of image adjustment employing the inkjet head 17a at the joint portion of the first head module 11 and the inkjet head 17c at the joint portion of the second head module 12, the amount of image adjustment is reflected in the amounts of image adjustment for the other inkjet heads 17 included in the first head module 11 and the second head module 12. This enables image adjustment through simple calculation processing.

Still further, in the inkjet printing system 1 of the embodiment described above, increasing the number of inkjet heads 17 that print the position adjustment pattern when the inkjet head 17a at the joint portion is replaced enables higher precision image adjustment.

Still yet further, in the inkjet printing system 1 of the embodiment described above, in the case that the system acquires the readable size of the image reading device 30 and changes the number of inkjet heads 17 at the joint portion according to the acquired readable size, it is possible to perform image adjustment with the highest possible precision.

In addition, in the inkjet printing system 1 of the embodiment described above, image adjustment (adjustment of the ink ejection timing and the drive voltage) is performed between the first head module 11 and the second head module 12 which are configured separately. When performing printing processing by arranging a plurality of inkjet heads within a single head module in a direction perpendicular to the conveyance direction, it is also possible to divide the head module into a plurality of head groups in the direction perpendicular to the conveyance direction and employ an image adjusting method similar to that of the inkjet printing system 1 of the embodiment described above for image adjustment between these head groups.

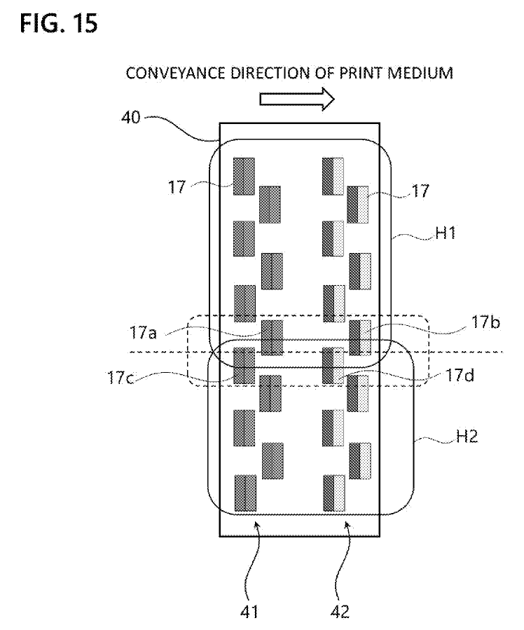

FIG. 15 illustrates an example of a head module 40 configured with a plurality of inkjet heads 17 arranged in a direction perpendicular to the conveyance direction as described above. The head module 40 illustrated in FIG. 15 includes line heads 41 and 42. The line head 41 is equipped with eleven inkjet heads 17 arranged in a staggered pattern in the direction perpendicular to the conveyance direction. Each of the inkjet heads 17 in line head 41 ejects K (black) and C (cyan) ink. The line head 42 is equipped with eleven inkjet heads 17 arranged in a staggered pattern in the direction perpendicular to the conveyance direction. Each of the inkjet heads 17 in the line head 41 ejects M (magenta) and Y (yellow) ink.

In the case that the ink ejection timing is adjusted for each of the inkjet heads 17 in the head module 40, the inkjet heads 17 are divided into a head group H1 for the upper inkjet heads 17 and a head group H2 for the lower inkjet heads 17. Then, two copies each of the aforementioned position adjustment pattern and density adjustment pattern are printed employing all of the inkjet heads 17 in the head module 40. Next, from the first position adjustment pattern, the range of the position adjustment pattern for head group H1 is cropped to obtain read-out image data. The ink ejection timing among the inkjet heads 17 within head group H1 is adjusted to obtain the adjustment values for the ink ejection timing of each of the inkjet heads 17 based on this read-out image data. In addition, from the second position adjustment pattern, the area corresponding to the position adjustment pattern for head group H2 is cropped to acquire read-out image data. The ink ejection timing among the inkjet heads 17 within head group H2 is adjusted, and the adjustment values for the ink ejection timing of each inkjet head 17 are obtained based on this read-out image data.

Next, a position adjustment pattern is printed to acquire read-out image data employing inkjet heads 17a to 17d at a joint portion between the head group H1 and the head group H2. The amount of adjustment for the ink ejection timing between head group H1 and head group H2 is obtained based on this read-out image data.

Finally, the amount of adjustment for the ink ejection timing between the head group H1 and the head group H2 is added to the adjustment value for the ink ejection timing of each of the inkjet heads 17 in the head group H1 and to the adjustment value for the ink ejection timing of each of the inkjet heads 17 in the head group H2.

Next, with respect to the adjustment of the drive voltage for each of the inkjet heads 17 in the head module 40, the range of the density adjustment pattern for the head group H1 is cropped from the first density adjustment pattern to obtain read-out image data. The drive voltage between inkjet heads 17 within head group H1 is adjusted to obtain the drive voltage adjustment values for each of the inkjet heads 17 based on this read-out image data. In addition, the range of the density adjustment pattern for head group H2 is cropped from the second density adjustment pattern to acquire read-out image data. The drive voltage among the inkjet heads 17 within the head group H2 is adjusted to obtain the adjustment value for the drive voltage of each of the inkjet heads 17 based on this read-out image data.

Then, a density adjustment pattern is printed employing inkjet heads 17a through 17d at the joint portion between the head group H1 and the head group H2 to acquire read-out image data. The amount of adjustment for the drive voltage between head group H1 and head group H2 is obtained based on this read-out image data.

Finally, the amount of adjustment for the drive voltage between the head group H1 and the head group H2 is added to the drive voltage adjustment value for each of the inkjet heads 17 in the head group H1 and to the drive voltage adjustment value for each of the inkjet heads 17 in the head group H2.

In addition, in the inkjet printing system 1 of the embodiment described above, the first head module 11 and the second head module 12 are fixed, and the print medium P is conveyed. However, the present disclosure is not limited to such a configuration. The position of the print medium P may be fixed, and the first head module 11 and the second head module 12 may be moved. or the first head module 11 and the second head module 12 and the print medium P may be moved in opposite directions relative to each other.

Note that the present disclosure is not limited to the embodiment described above and may be embodied by modifying components within a scope that does not deviate from its essence during implementation. Furthermore, various inventions can be formed by appropriately combining the plurality of components which are disclosed in the embodiment described above. For example, all of the components which are disclosed in the embodiment may be appropriately combined. It goes without saying that various modifications and applications are possible within a scope that does not deviate from the spirit of the disclosure.

The additional items below are disclosed with respect to the present disclosure.

### Item 1

The image adjusting method of the present disclosure is an image adjusting method for an inkjet printing device that includes a plurality of head groups each having a plurality of inkjet heads with a plurality of nozzles that eject ink onto a print medium, the inkjet heads in each head group being arranged along a direction perpendicular to a conveyance direction of at least one of the print medium and the inkjet heads, the head groups being arranged along the direction perpendicular to the conveyance direction, wherein an image adjustment pattern that spans a joint portion between two head groups that are arranged adjacent to each other in a direction perpendicular to the conveyance direction is printed employing a portion of the inkjet heads in the two head groups, a read-out image is acquired by reading the printed image adjustment pattern with a readout unit, and an amount of image adjustment for the inkjet heads in the two head groups is determined based on the read-out image.

### Item 2

In the image adjusting method according to Item 1, the two head groups may be two separately configured head modules.

### Item 3

In the image adjusting method according to Item 1 or 2, the amount of image adjustment between the two head groups may be determined after performing image adjustment between inkjet heads included in each of the head groups.

### Item 4

In the image adjusting method according to Item 3, after determining the amount of image adjustment between the two head groups, the amount of image adjustment may be reflected in the amount of image adjustment for each of the inkjet heads included in each of the head groups.

### Item 5

In the image adjusting method according to any one of Items 1 through 4, when the inkjet head that prints the image adjustment pattern is replaced, the number of inkjet heads that print the image adjustment pattern may be increased.

### Item 6

In the image adjusting method according to any one of Items 1 through 5, readable size information of the readout unit may be acquired, and the number of inkjet heads that print the image adjustment pattern may be changed based on the acquired readable size information.

### Item 7

In the image adjusting method according to any one of Items 1 through 6, the amount of image adjustment may include at least one of the amount of adjustments for an ink ejection timing, a drive voltage, and an installation angle of the inkjet head.

### Item 8

An image adjusting apparatus for performing image adjustment on an inkjet printing device that includes a plurality of head groups each having a plurality of inkjet heads with a plurality of nozzles that eject ink onto a print medium, the inkjet heads in each head group being arranged along a direction perpendicular to a conveyance direction of at least one of the print medium and the inkjet heads, the head groups being arranged along the direction perpendicular to the conveyance direction, the image adjusting apparatus comprising a control unit that drives and controls printing of an image adjustment pattern that spans a joint portion between two adjacent head groups arranged in the direction perpendicular to the conveyance direction, and that is printed employing a portion of the inkjet heads in the two head groups, a readout image acquiring unit that acquires a read-out image by having a readout unit read the image adjustment pattern, and an adjustment amount calculating unit that calculates an amount of image adjustment for the inkjet heads in the two head groups based on the read-out image.

What is claimed is:

1. An image adjusting method for an inkjet printing device that includes a plurality of head groups each having a plurality of inkjet heads with a plurality of nozzles that eject ink onto a print medium, the inkjet heads in each head group being arranged along a direction perpendicular to a conveyance direction of at least one of the print medium and the inkjet heads, the head groups being arranged along the direction perpendicular to the conveyance direction, the image adjusting method comprising:
printing an image adjustment pattern that spans a joint portion between two head groups that are arranged adjacent to each other in a direction perpendicular to the conveyance direction employing a portion of the inkjet heads in the two head groups;
acquiring a read-out image by reading the printed image adjustment pattern with a readout unit; and
determining an amount of image adjustment for the inkjet heads in the two head groups based on the acquired read-out image.

2. The image adjusting method according to claim 1, wherein:
the two head groups are two head modules which are configured separately.

3. The image adjusting method according to claim 1, wherein:
the amount of image adjustment between the two head groups is determined after performing image adjustment between the inkjet heads included in each head group of the two head groups.

4. The image adjusting method according to claim 3, wherein:
after determining the amount of image adjustment between the two head groups, the amount of image adjustment is reflected in the amount of image adjustment of the inkjet heads included in each of the head groups.

5. The image adjusting method according to claim 1, wherein:
the number of inkjet heads that print the image adjustment pattern is increased when the inkjet head that prints the image adjustment pattern is replaced.

6. The image adjusting method according to claim 1, wherein:
readable size information of the readout unit is acquired; and
the number of inkjet heads that print the image adjustment pattern is changed based on the acquired readable size information.

7. The image adjusting method according to claim 1, wherein:
the amount of image adjustment includes at least one of the amounts of adjustment for an ink ejection timing, a drive voltage, and an installation angle of the inkjet head.

8. An image adjusting apparatus for performing image adjustment on an inkjet printing device that includes a plurality of head groups each having a plurality of inkjet heads with a plurality of nozzles that eject ink onto a print medium, the inkjet heads in each head group being arranged along a direction perpendicular to a conveyance direction of at least one of the print medium and the inkjet heads, the head groups being arranged along the direction perpendicular to the conveyance direction, comprising:
a control unit that drives and controls printing of an image adjustment pattern that spans a joint portion between two adjacent head groups arranged in the direction perpendicular to the conveyance direction, and that is printed employing a portion of the inkjet heads in the two head groups;
a readout image acquiring unit that acquires a read-out image by having a readout unit read the image adjustment pattern; and
an adjustment amount calculating unit that calculates an amount of image adjustment for the inkjet heads in the two head groups based on the read-out image.
